(19) United States
(12) Patent Application Publication
(10) Pub. No.: US 2021/0109495 A1
(43) Pub. Date: Apr. 15, 2021

(54) Display Unit For A Measuring Device For Processing And Automation Technology, And Measuring Device Having A Display Unit Of This Type

(71) Applicant: IFM Electronic GMBH, Essen (DE)

(72) Inventors: Walter Reichart, Fronreute (DE); Tobias May, Meckenbeuren (DE)

(21) Appl. No.: 16/496,661

(22) PCT Filed: Mar. 23, 2018
(86) PCT No.: PCT/DE2018/100265

§ 371 Date: Sep. 23, 2019

(30) Foreign Application Priority Data
Mar. 24, 2017 (DE) 10 2017 204 980.4

(51) Int. Cl. G05B 19/401; G06F 3/0488

(52) U.S. Cl. CPC G05B 19/401; G06F 1/1607; G06F 2200/1614; G06F 3/04886

(57) ABSTRACT

The invention relates to a display unit for a measuring device for processing and automation technology, comprising a rectangular, but not square, graphic display (3), on which different measurement and/or parameter data of the measuring device (1) can be displayed, wherein the display (3) can be rotated in 90° steps relative to the display unit (2), such that the displayed measurement and/or parameter data can always be oriented horizontally regardless of a rotation of the display unit (2) in the vertical plane. The display (3) has at least two square sub-regions (4a, 4b) and these square sub-regions (4a, 4b) can be rotated independently of one another. The invention also relates to a measuring device for processing and automation technology comprising a display unit of this type.

The invention relates to a display unit for a measuring device for processing and automation technology, and also to a measuring device having a display unit of this type.

In automation and processing technology, sensors or measuring devices are frequently used which convert the captured measured value—for example pressure, temperature, flow rate, but also distance or vibration—into an output signal in the form of an analog or digital current or voltage signal representing this measured value, and provide this signal to their cable or plug connection, but in some instances also wirelessly to a higher-level control unit, for example a PLC.

A typical measuring device consists first of all of a sensor element, also designated as a measured value recorder, which serves for detecting and converting a physical measurement variable of a processing value into a measurement signal. Furthermore, an evaluation unit is provided which is frequently configured as a microcontroller and in which the measurement signals generated by the sensor element are conditioned, that is to say amplified, and generally are also already processed. The evaluation unit is connected at the output end to a communication interface, by means of which the conditioned measurement signals can be transmitted to the aforementioned control unit. The measuring device frequently also comprises a display unit, on which, amongst other things, the current measurement values are displayed. Furthermore, the display unit frequently also serves for setting up and parameterizing the measuring device. For this purpose, the measuring device additionally has corresponding input options.

In the case of the display units, for many years segment displays have been known, by which numbers and letters can be displayed in a graphically simple manner. Furthermore, nowadays there are also graphic displays, for example based on LCDs or LEDs, on which, depending upon the resolution of the graphical interface, even sophisticated representations of numbers, letters and symbols are possible, in some instances also in multiple colors.

On the other hand, in various applications there is a requirement that the display can always be read easily, so that it is always oriented horizontally, regardless of the installation of the measuring device. In the case of graphic displays, it is possible, instead of mechanically rotating the entire display unit, merely to change the orientation of the representation, that is to say the display itself. Instead of a mechanical rotation, this object is achieved by corresponding software.

In the case of square display windows, this is largely problem-free because, in the event of a rotation in 90° steps, nothing changes with regard to the perception of the display itself. However, in the case of a rectangular, non-square, arrangement, for example in 16:9 format, because of the transposition of height and width, a rotation constitutes a significant alteration of the representation if the displayed data originally displayed in landscape format using the entire width is now displayed in portrait format.

Therefore, the object of the invention is to facilitate a representation on a graphic display for a measuring device of the type referred to above, which can also be rotated in a non-square configuration and nevertheless can be read simply and completely.

This object is achieved according to the invention by a display unit with the features according to claim 1 as well as a measuring device with the features according to claim 5. Advantageous embodiments of the invention are set forth in the sub-claims.

According to the invention, measurement and/or parameter data of the measuring device in the case of a vertical arrangement of the non-square display unit can be oriented horizontally in the vertical plane regardless of a rotation of the display unit, and thus can be read easily and completely. Because the display has at least two square sub-regions and these square sub-regions can be rotated independently of one another, that is to say they each have their own axis of rotation, the two square sub-regions can be arranged alongside one another in the case of horizontal orientation of the display unit and one above the other in the case of vertical orientation. In this case, the representation in the sub-regions themselves remains unchanged even after a rotation, because height and width are identical due to the square shape.

The two side lengths of the square sub-regions together advantageously correspond to the width of the rectangular display, so that the entire display surface is filled by the two squares and is therefore well utilized.

In the case of a measuring device which has such a display unit, regardless of the installation position of the measuring device, the display can always be oriented so that it can be read easily due to the horizontal alignment and the non-distorted representation.

In an advantageous embodiment, the display unit is rigidly and non-rotatably connected to the actual measuring device, so that there is no need for high expenditure, for example, for sealing, and nevertheless a good legibility of the displayed values can be achieved.

The invention is explained in greater detail below on the basis of embodiments with reference to the drawings.

In the schematic drawings:

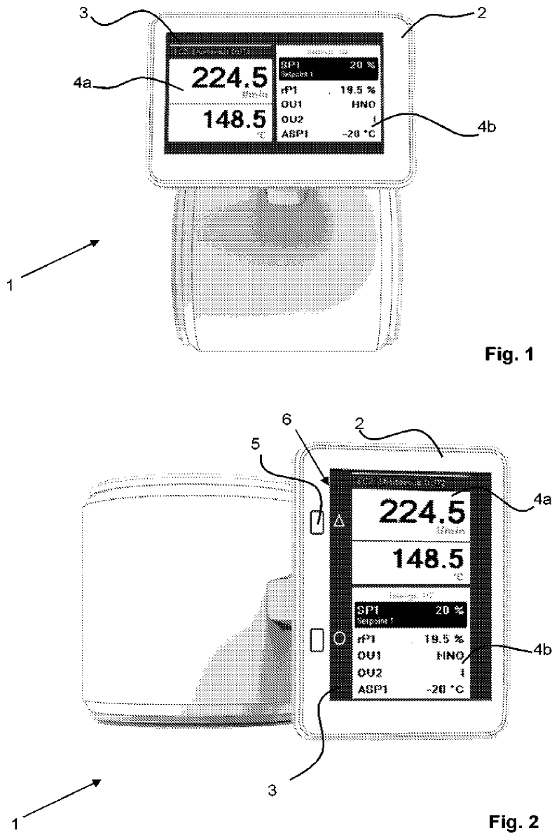

FIG. 1 shows a measuring device for processing and automation technology comprising a display unit in a horizontal installation position, and

FIG. 2 shows the measuring device according to FIG. 1 in a vertical installation position.

In the following description of the preferred embodiments, the same reference numerals designate identical or comparable components.

FIG. 1 shows a measuring device 1 for processing and automation technology in the form of an electromagnetic flow meter (EMF), which in the present case is illustrated in a horizontal installation position. The display unit 2 is arranged offset from the actual measuring device 1 and comprises a rectangular, but not square, graphic display 3 based on LCDs or LEDs, on which different measurement and/or parameter data of the measuring device 1 are displayed. The display 3 consists substantially of two square sub-regions 4a, 4b, wherein current measured values in the form of flow rate and medium temperature are displayed in the first region 4a and parameter data or setting values such as switch points and the like are displayed in the second region 4b. The menu operation takes place either by means of operating buttons (not shown here) or also by means of touching the display surface 3, if the display is configured as a so-called touchscreen.

In FIG. 2, the measuring device 1 is illustrated in a vertical installation position, that is to say the entire measuring device 1 including the display unit 2 is now rotated by 90° relative to the horizontal installation position. In order to read the display 3 easily, the displayed measuring and parameter data should again be oriented horizontally. Therefore, the two square sub-regions 4a, 4b are in each case arranged rotated by 90° and one above the other. The special feature now is that the entire display 3 is not rotated, which would lead to an alteration of the width-height ratio, but that because of the sub-division into the two square sub-regions 4a, 4b, these sub-regions can be rotated independently of one another and because of the square configuration the width-height ratio is maintained.

Furthermore, FIG. 2 shows the display unit 2 with the aforementioned operating unit 5 in the form of two buttons as an exemplary embodiment. The two buttons 5 are provided in order also to be able to operate the measuring device 1 in situ. A narrow window inside the display 3 is associated with these buttons 5, and the functionalities of the buttons 5 are displayed in this window. In this case, the respective functionality may also be variable as a function of the menu position. The respective functionality is displayed by an element in the form of a symbol or an inscription. In the event of a rotation of the measuring device 1, the displayed elements rotate correspondingly, in order to be in the reading direction relative to the two square sub-regions 4a, 4b. The association with the buttons 5 and the position of the individual symbols remains unchanged.

As a result, the advantage of the invention also resides in the fact that the display unit 2 does not have to be rotatable with respect to the actual measuring device 1, which is frequently associated with high expenditure, for example for the sealing, in particular if the measuring device 1 is to be used in hygienic areas.

1. A display unit for a measuring device for processing and automation technology, comprising a rectangular, but not square, graphic display (3), on which different measurement and/or parameter data of the measuring device (1) can be displayed,
wherein the display (3) can be rotated in 90° steps relative to the display unit (2), such that the displayed measurement and/or parameter data can always be oriented horizontally, regardless of a rotation of the display unit (2) in the vertical plane,
wherein the display (3) has at least two square sub-regions (4a, 4b), and the square sub-regions (4a, 4b) can be rotated independently of one another.

2. The display unit according to claim 1, wherein the two side lengths of the sub-regions (4a, 4b) together correspond to the width of the rectangular display (3).

3. The display unit according to claim 1 or 2, wherein the display has a side ratio of 16:9.

4. The display unit according to claim 1, wherein an operating unit (5) in the form of at least one button is provided and the display (3) has a region (6) which is associated with the at least one button and displays the functionality thereof.

5. A measuring device for processing and automation technology, comprising a display unit (2) with a rectangular, but not square, graphic display (3), on which different measurement and/or parameter data of the measuring device (1) can be displayed, wherein the display (3) can be rotated in 90° steps relative to the display unit (2), such that the displayed measurement and/or parameter data can always be oriented horizontally, regardless of the installation position of the measuring device (1), and wherein the display (3) has at least two square sub-regions (4a, 4b), and the square sub-regions (4a, 4b) can be rotated independently of one another.

6. The measuring device according to claim 5, wherein the two side lengths of the sub-regions (4a, 4b) together correspond to the width of the rectangular display (3).

7. The measuring device according to claim 5 or 6, wherein the display unit (2) is rigidly and non-rotatably connected to the measuring device (1).

8. The measuring device according to claim 5, wherein the display (3) has a side ratio of 16:9.

9. The measuring device according to claim 5, wherein the display unit (2) comprises an operating unit (5) in the form of at least one button, and the display (3) has a region (6) which is associated with the at least one button and displays the functionality thereof.
